(19) United States
(12) Patent Application Publication
(10) Pub. No.: US 2007/0271530 A1
(43) Pub. Date: Nov. 22, 2007

(54) Method and apparatus for the menu-controlled selection of menu items which have associated files containing audio and/or video data

(75) Inventors: Martin Klos, Schonaich (DE); Rolf Hartmann, Stuttgart (DE)

Correspondence Address: LERNER GREENBERG STEMER LLP, P O BOX 2480, HOLLYWOOD, FL, 33022-2480, US

(73) Assignee: Dr. Ing. h.c. F. Porsche AG

(21) Appl. No.: 11/804,682

(22) Filed: May 18, 2007

(30) Foreign Application Priority Data
May 18, 2006 (DE) 102006023226.7-53

(51) Int. Cl. G06F 3/048

(52) U.S. Cl. 715/825; 715/810

(57) ABSTRACT

A method and an apparatus allow for the menu-controlled selection of menu items which have associated files containing audio and/or video data. A first menu level with a plurality of first menu items and a second menu level with a plurality of second menu items, which are dependent on a first selection of one of the first menu items, are shown successively on a display device. After selection of one of the second menu items, the first menu level with the plurality of first menu items is shown again. This allows the plurality of first menu items to be able to be selected randomly after the first menu level has been shown again. The user can therefore select any of the menu items on the first menu level as desired. He is not restricted in his selection in any way.

### CROSS-REFERENCE TO RELATED APPLICATION

This application claims the priority, under 35 U.S.C. § 119, of German application DE 10 2006 023 226.7-53, filed May 18, 2006; the prior application is herewith incorporated by reference in its entirety.

### BACKGROUND OF THE INVENTION

### Field of the Invention

The present invention relates to a method and an apparatus for the menu-controlled selection of menu items which have associated files containing audio and/or video data. A first menu level with a plurality of first menu items and a second menu level with a plurality of second menu items are shown successively on a display device. The choice of which of the plurality of second menu items is to be displayed is dependent on a first selection of one of the first menu items.

Such a method and such an apparatus are known from U.S. Pat. No. 6,928,433 B2. U.S. Pat. No. 6,928,433 B2 discloses menu-controlled selection of tracks which are associated with audio or video data, particularly pieces of music in digital form. These audio or video data are stored on a storage medium for a portable media player together with associated metadata, which contain information such as a name of an artist or musical group, album, track and musical style. The selectable tracks are associated with various categories using their metadata. Such categories are artist, album and musical style. In this case, the selectable tracks are associated with a plurality of these categories. They are selected using a plurality of hierarchic menu levels shown successively on a display. A first, top menu level contains the categories. A hierarchically subordinate second menu level contains subcategories for the categories. For the Artist category, for example, these are the names of the various musicans and musical groups for whom selectable tracks are stored, for the Album category the titles of various albums from which selectable tracks are stored, and for the musical style category various available musical styles, such as rock, pop, classical etc. A third menu level, which is hierarchically subordinate to the second menu level, contains further elements. By way of example, these further elements may be the tracks, i.e. the titles of the individual selectable audio or video data. To select one or more tracks, the first menu level with the various categories is first of all opened to a user. The user selects one of these categories, for example the Albums category. Next, the second menu level is shown, which contains subcategories which are dependent on the selected category, for example the titles of available albums. From these subcategories, the user can again select one, for example one of the titles of the available albums. The third menu level is then shown, which contains further elements dependent on the selected subcategory, for example the tracks which the selected album contains. In the case of the system from U.S. Pat. No. 6,928,433 B2, the user can use the first menu level to select the category with which he wishes to begin the search and track selection. The subcategories shown in the immediately subsequent second menu level are then obtained directly from the selected category etc. Therefore, following selection of the category the user is no longer free to choose the way in which he wishes to continue the selection on the basis of a track. Rather, further branching to the further subordinate menu levels is prescribed strictly according to the hierarchy starting from the selection of the category in the top menu level.

### SUMMARY OF THE INVENTION

It is accordingly an object of the invention to provide a method and an apparatus for the menu-controlled selection of menu items which have associated files containing audio and/or video data which overcome the above-mentioned disadvantages of the prior art methods and devices of this general type, which allows a user to select audio and/or video data conveniently and easily.

With the foregoing and other objects in view there is provided, in accordance with the invention, a method for menu-controlled selection of menu items having associated files containing audio data and/or video data. The method includes showing successively a first menu level having a plurality of first menu items and a second menu level having a plurality of second menu items on a display device, the plurality of second menu items is dependent on a first selection of one of the first menu items. The first menu level with the plurality of first menu items is displayed again after a selection of one of the second menu items.

In the method, after selection of one of the second menu items the first menu level with the plurality of first menu items is shown again. In the case of an apparatus, the control device is also in a form such that it controls renewed showing of the first menu level with the plurality of first menu items after selection of one of the second menu items. In line with the present invention, the second menu level is hierarchically subordinate to the first menu level. The first menu items on the first menu level are not hierarchic, however. The plurality of first menu items can therefore advantageously be selected randomly after the first menu level has been shown again. The user can select any of the menu items on the first menu level as desired. He is in no way restricted in his selection. A user can therefore determine and stipulate the order of selection of the various menu items for selecting audio and/or video data largely himself. The invention provides a simple manner of convenient filter-based selection of and searching for audio and/or video data.

In one advantageous refinement of the invention, after a second selection of one of the first menu items from the first menu level shown again, the second menu level is shown with second menu items which are dependent on the first and the second selection of one of the first menu items. The user is therefore taken to the desired audio and/or video data quickly and directly.

Preferably, when the first menu level is shown again one of the first menu items is deactivated if the preceding selection of the second menu item results in that upon the second selection of this first menu item it would not be possible to select second menu items on the second menu level. This makes it possible to prevent the user from selecting a first menu item which gives him no further selection option in the second menu level. This increases convenience further.

In another advantageous refinement, after the selection of one of the second menu items when the first menu level is shown again a statement associated with this selected second menu item is shown in the first menu level. This ensures a particularly high level of clarity, since the user is able to tell in the first menu level what selection he has already made previously.

In one particularly preferred refinement of the invention, at least one of the first menu items and/or of the second menu items has a statement added to it about a number of associated files. This gives the user a good overview of how many files containing audio and/or video data are concealed by the at least one menu item. This allows him to estimate, if appropriate, how laborious or complex selection will be.

One particular preference is that a result for the menu-controlled selection of the menu items is shown, the result containing at least one title which represents selected audio and/or video data. The result provides the user with a direct overview of the selected audio and/or video data. If appropriate, it is possible to restrict or expand the result further.

In one advantageous refinement, the result is shown together with a file directory for a storage medium on which the files containing the audio and/or video data are stored. This provides the user with another selection option of accessing the files by the menu-controlled selection carried out previously or by use of a file directory. In particular, the file directory may be in tree form with folders which have been set up beforehand.

In another advantageous refinement, the files are stored in a database. This ensures particularly simple and safe access to the audio and/or video data.

Preferably, the inventive method is performed using a multimedia device. This may be present in a motor vehicle, in particular. Specifically in a motor vehicle, it is advantageous for the audio and/or video data to be selected easily and conveniently so that a driver is not diverted from what is happening on the road during selection.

The multimedia device may also advantageously have an interface for connecting to a portable storage medium. After connection of the storage medium to the interface, metadata which are stored on the storage medium and which are associated with files stored on the storage medium containing audio and/or video data are read. This allows the user to feed in any, arbitrarily selectable audio and/or video data or to have them available for selection. Audio and/or video data can easily be ported by other technical equipment.

With particular preference, the files stored on the storage medium are associated with the first and second menu items using the metadata which have been read. This can be done largely automatically, in particular. This is a particularly simple and rapid way of assembling a structured selection option for audio and/or video data which the user can then access. The metadata can also be allocated by the user himself, so that the selection option can be geared very specifically to the user.

Preferably, the files stored on the storage medium are read and are stored in the multimedia device. To this end, the latter may contain a memory. The audio and/or video data can therefore be selected and accessed particularly quickly. In addition, it is possible for the user to use the storage medium for other purposes.

Other features which are considered as characteristic for the invention are set forth in the appended claims.

Although the invention is illustrated and described herein as embodied in a method and an apparatus for the menu-controlled selection of menu items which have associated files containing audio and/or video data, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a multimedia device used in a motor vehicle according to the invention;

FIG. 2 is a block diagram illustrating menu levels for selecting audio data following a first selection of a first menu item from a first menu level;

FIG. 3 is a block diagram illustrating the menu levels for selecting audio data following a second selection of a first menu item;

FIG. 4 is a block diagram illustrating a menu level with a deactivated first menu item;

FIG. 5 is a block diagram illustrating a menu level and a result list following full selection of audio data; and

FIG. 6 is a block diagram illustrating menu levels with a menu item for a result of a concluded menu-controlled selection of audio data and a file directory.

### DESCRIPTION OF THE PREFERRED EMBODIMENTS

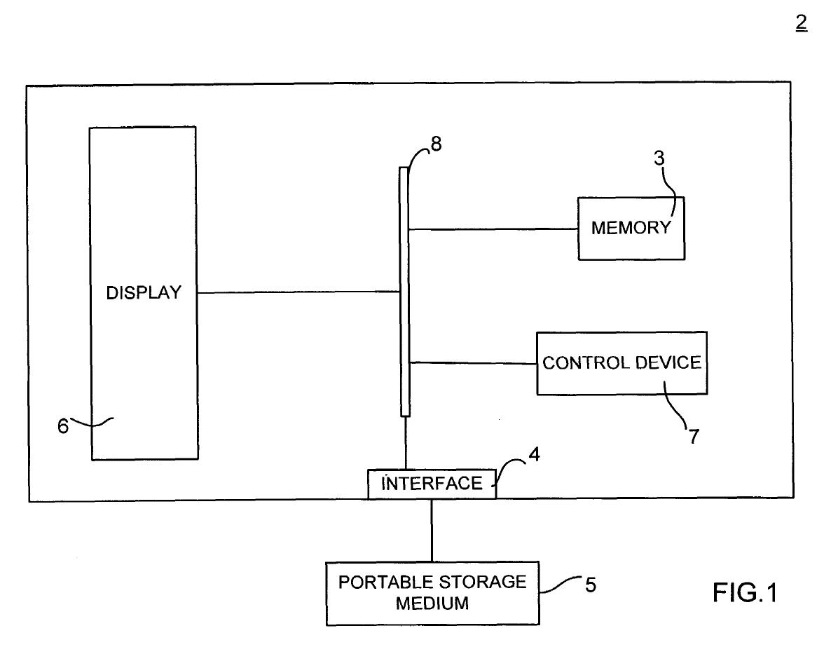

In the text which follows, the same reference symbols have been used throughout for elements which are the same or have the same action. Referring now to the figures of the drawing in detail and first, particularly, to FIG. 1 thereof, there is shown a schematic basic illustration of an inventive apparatus, which is in the form of a multimedia device 1 in this instance. The multimedia device 1 is used in a motor vehicle 2 in the present exemplary embodiment. The motor vehicle contains a radio, a CD player, an MP3 player, a navigation appliance and further components. The multimedia device 1 has a memory 3 for storing digital audio and/or video data and an interface 4 to which a portable storage medium 5 can be connected. In this case, the interface 4 is what is known as an universal synchronous bus (USB) interface. The portable storage medium 5 may be a USB stick or a mobile hard disk, for example. The multimedia device 1 also contains a display device 6 for displaying a visual, particularly menu-controlled, user interface, for displaying videos, navigation information and other information. A control device 7 is used to control the processes and functions of the multimedia device 1. It is used particularly to control the menu-controlled user interface. The various components of the multimedia device 1 are connected to one another by a bus 8.

The storage medium 5 stores a large number of files containing audio data which correspond to pieces of music or music productions. In this case, the audio data are stored in MP3 format. However, it is also possible to use other formats, such as WMA or AAC. In addition, it is also possible for video data, for example from a music video, or other contents to be held on the storage medium 5 in addition or as an alternative to the audio data. The files may have associated additional metadata with statements relating to the contents of the files. In the case of the audio data with pieces of music, such metadata are particularly information relating to the artists, to the albums on which the individual pieces of music are held, to the tracks from the pieces of music and relating to musical styles with which the pieces of music may be associated. Since the audio data are available in MP3 format here, the metadata are stored as what are known as ID3-tags. The files are stored on the storage medium 5 using a prescribed file system. For this, the storage medium 5 holds a file directory which contains the structure for storing the files. By way of example, the files may be stored in the manner of a file system which is divided into various folders, as is known particularly from the program Windows Explorer in the computer operating system Microsoft Windows.

To select audio data, a user of the multimedia device 1 connects the storage medium 5 to the interface 4. In this case, this is detected by the multimedia device 1 substantially automatically, so that the control device 7 prompts the metadata to be read from the storage medium 5. Using the metadata which have been read, the files stored on the storage medium 5 are associated with prescribed categories. The categories correspond to individual menu items on a menu level in a menu on the user interface for selecting the audio data. In this context, the categories are particularly artists, albums, tracks and musical styles. The multimedia device 1 uses the metadata to compile a database which allows structured, simple access to the individual files containing the audio data using the various categories. The database and particularly the references and associations between the individual files and the various categories may advantageously be implemented by use of pointers. The database is stored in the memory 3, but may alternatively or additionally be stored on the storage medium 5. It is possible for the control device 7 to control reading of the audio data stored on the storage medium 5 and storage thereof in the memory 3. In this case, the files containing the audio data are likewise available in the multimedia device 1. The user can then remove the storage medium 5 from the interface 4 and use it for other purposes. The pieces of music can later be played back by accessing the memory 3 and do not necessarily need to be played back by accessing the connected storage medium 5 via the interface 4. This allows faster access. Nevertheless, it is also possible to access the files stored on the storage medium 5 when the storage medium is connected. Advantageously, the user can stipulate whether the files need to be loaded into the memory 3. Following creation of the database containing the metadata and/or the files containing the audio data, the multimedia device 1 can stipulate, when the same or another storage medium 5 is connected to the interface 4 again, whether the files stored thereon and their associated metadata are the same as previously. Changes to the composition of the files and the metadata are advantageously detected automatically, so that a new database can be set up or the already existing database can be adapted. The database can then be searched using a filter-based search which is implemented in the control device 7.

The filter-based search on the basis of the categories and metadata can be used for directly selecting pieces of music and files associated with them and compiling them into a result list which can then be accessed to play back the pieces of music on the MP3 player of the multimedia device 1. The filter-based search is performed using the visual user interface displayed on the display device 6. The search is menu-controlled, so that various menu levels are set up in succession which list menu items which can be selected by the user. The selection can be made through suitable activation of keys on the multimedia device 1 or by touching an appropriately marked field on the display device 6, for example. The filter-based search is controlled by the control device 7.

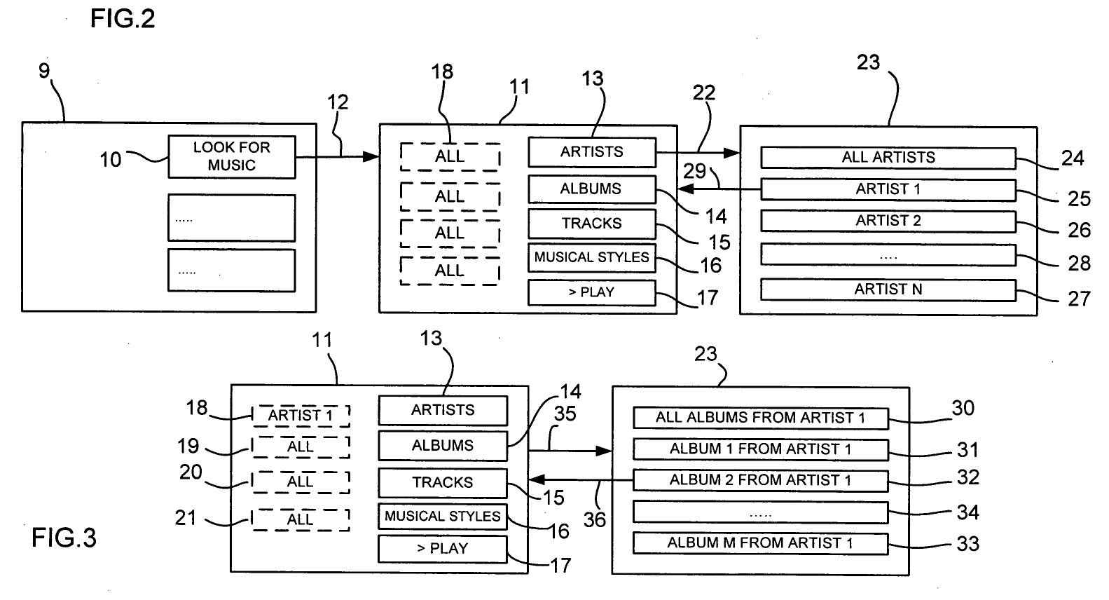

FIG. 2 shows an exemplary illustration of three menu levels for selecting audio and/or video data. The menu levels are displayed in succession on the display device 6, with the individual menu levels being in hierarchic form relative to one another. FIG. 2 shows a main menu level 9 which contains a menu item 10, Look For Music, which is used to select a service on the multimedia device 1 that is used to look for pieces of music. When menu item 10 has been selected, a first menu level 11 is set up. This process is illustrated in FIG. 2 by an arrow 12 pointing from menu item 10 to the first menu level 11. The first menu level 11 contains two columns arranged next to one another with menu items. The right-hand column shows the categories Artists, Albums, Tracks and Musical styles as first menu items 13, 14, 15 and 16. In addition, the right-hand column contains a first menu item 17, Play. In the left-hand column of the first menu level 11, the first menu items 13-16 have associated fields 18, 19, 20 and 21 which show a selection in one of the categories which the user may have made previously. In the exemplary embodiment shown in FIG. 2, no such selection has yet been made, which results in that the fields 18-21 indicate that all the contents of the respective category are detected.

Upon selection of menu item 17, Play, the multimedia device 1 is prompted to play back hitherto selected and compiled pieces of music using the MP3 player and to access the files associated with these pieces of music. When one of the first menu items 13-16 is selected, the user can restrict the search for pieces of music further and branch to the category associated with the respectively selected menu item 13-16. By way of example, in FIG. 2 the selection of menu item 13, Artists, is identified by an arrow 22 which points from menu item 13 to a second menu level 23. The display of the second menu level 23 on the display device 6 is controlled via the control device 7. The second menu level 23 contains a plurality of second menu items. A top second menu item 24 contains all the selection options combined under the selected category. In the present case, the second menu item 24 contains all the available artists. Selection of the second menu item 24 would therefore not involve any restrictive selection being made for the Artists category, but rather all the available artists would be selected. Besides the second menu item 24, the second menu level 23 contains further second menu items which are associated with individual artists. FIG. 2 shows a second menu item 25 for an artist 1, a second menu item 26 for an artist 2, a second menu item 27 for an artist n and a second menu item 28 to represent an arbitrary number, situated between 2 and n, of further artists. In this case, n is a natural number. The number of second menu items on the second menu level 23 is dependent on the number of different artists available for selection. The user can now select one of the second menu items 24-28. In the present exemplary embodiment shown in FIG. 2, he selects menu item 25, Artist 1. This is shown by an arrow 29 which points from menu item 25 to the first menu level 11. This makes it clear that following selection of menu item 25 the invention involves a branch back to the first menu level 11 again.

FIG. 3 shows another illustration of the menu levels 11 and 23 for selecting pieces of music and audio data associated with them. To display to the user his previously made selection of artist 1, this selection is displayed in field 18. Field 18 now contains the information that artist 1 has been selected, for example by showing the name of artist 1. Having branched back from the second menu level 23 to the first menu level 11, the user is provided with the option of further restricting his selection to audio data and pieces of music. However, the user can likewise actuate menu item 17, Play, in order to prompt playback of all the pieces of music from artist 1. The user can also correct his selection of artist 1. To do so, he again actuates menu item 13, so that, as described above in connection with FIG. 2, the second menu level 23 is set up again and provides him with a fresh selection of artists by use of menu items 24-28. In principle, even after branching back to the first menu level 11, the user can make a random selection from its menu items 13-17. That is to say that the user can select any of menu items 13-17. He is in no way restricted in his selection options.

In the present exemplary embodiment shown in FIG. 3, the user wishes to restrict his selection further. He actuates menu item 14 and in so doing selects the Albums category. The display device 6 then sets up the second menu level 23 with new second menu items 30-34. This is illustrated in FIG. 3 by an arrow 35 which points from menu item 14 to the second menu level 23. These second menu items 30-34 represent the various albums from artist 1 which have pieces of music available from them here. Menu item 30 contains all the available albums from artist 1. Menu item 31 represents an album 1, menu item 32 represents an album 2, menu item 33 represents an album m and menu item 34 represents an arbitrary number, situated between 2 and m, of further albums from artist 1. In this case, m is a natural number. The number of second menu items on the second menu level 23 is dependent on the number of different albums from artist 1 which are available for selection. The user can now select one of the second menu items 30-34. In the present exemplary embodiment shown in FIG. 3, he selects menu item 32, Album 2. This is indicated by an arrow 36 which points from menu item 32 to the first menu level 11. This makes it clear that following selection of menu item 32 there is a branch back to the first menu level 11 again.

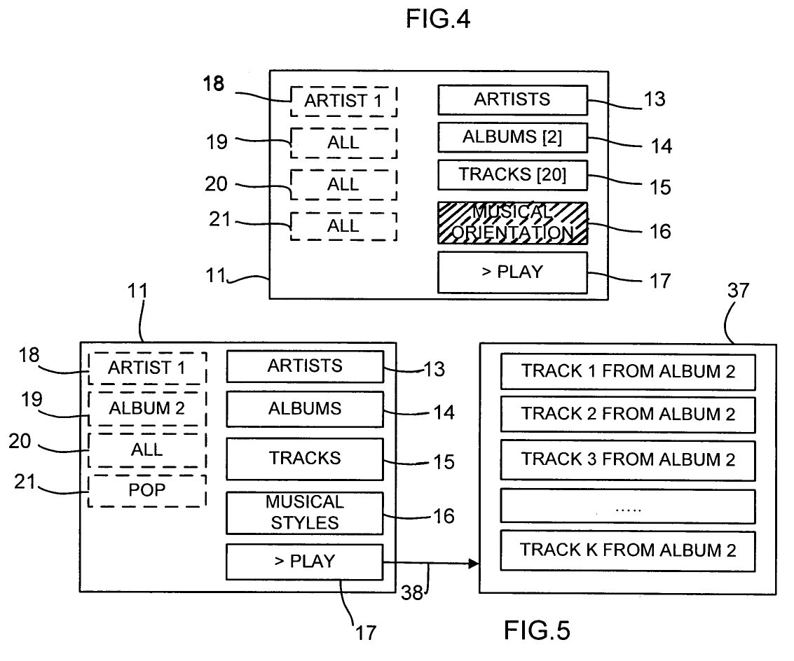

To achieve a particularly high level of convenience for the user, the menu items on the first menu level 11 and/or on the second menu level 23 can be used to indicate how many selection options are concealed by these individual menu items. In this regard, FIG. 4 shows another illustration of the first menu level 11 with the first menu items 13-17 in the right-hand column. As already described with reference to FIG. 3, the first menu level 11 in this case represents the situation where the user has previously selected artist 1. This is shown in field 18. Menu item 14, which represents the Albums category, uses a number two in brackets to additionally indicate to the user that, following selection of artist 1, menu item 14 has the option of selecting between two different albums from artist 1. If, in a subsequent selection, the user were to select menu item 14 then the second menu level would open with three menu items. Of these three menu items, one is associated with all, i.e. in this case both, available albums from artist 1 and the other two are associated with the two individual albums which are available. Menu item 15, which represents the Tracks category, furthermore uses a number twenty in brackets to indicate to the user that, following selection of artist 1, menu item 15 has the option of selecting between twenty different tracks from artist 1. If, in a subsequent selection, the user were to select menu item 15 then the second menu level would open with twenty-one menu items. Of these twenty-one menu items, one is associated with all, i.e. in this case the twenty, available tracks from artist 1 and the other twenty are associated with the twenty individual tracks which are available.

FIG. 4 also shows the first menu item 16 in a deactivated state. This indicates to the user that in this case menu item 16 does not conceal any further selection option. Actuation of menu item 16 would not get the user any further in his restrictive selection, so that this is advantageously indicated to him by the deactivation. In addition, field 21 could be filled with appropriate information, in particular automatically, e.g. with musical style 1, such as pop.

FIG. 5 shows an illustration of the first menu level 11. The left-hand column of the first menu level 11 indicates to the user the selection which he has previously made. In the present exemplary embodiment, field 18 indicates the selection of artist 1, field 19 indicates the selection of album 2, field 20 indicates no restrictive selection, i.e. all the tracks have been selected, and field 21 indicates the selection of the musical style pop. At this juncture, the user's selection is at an end and he wishes to play back the selected pieces of music. This is made possible by virtue of him actuating the first menu item 17, Play.

Alternatively, the multimedia device 1 may be in a form such that when the first menu item 17, Play, is actuated a result list 37 containing the tracks or titles from the pieces of music from the selection made is first of all shown on the display device 6. This is illustrated in FIG. 5 by an arrow 38 which points from menu item 17 to the result list 37. In this case, the result list 37 contains tracks 1 to k on album 2 from artist 1, whose music is associated with the musical style pop. In this case, k is a natural number. If menu item 17 were selected again, for example, tracks 1 to k in the result list 37 would then be played back sequentially by the multimedia device 1.

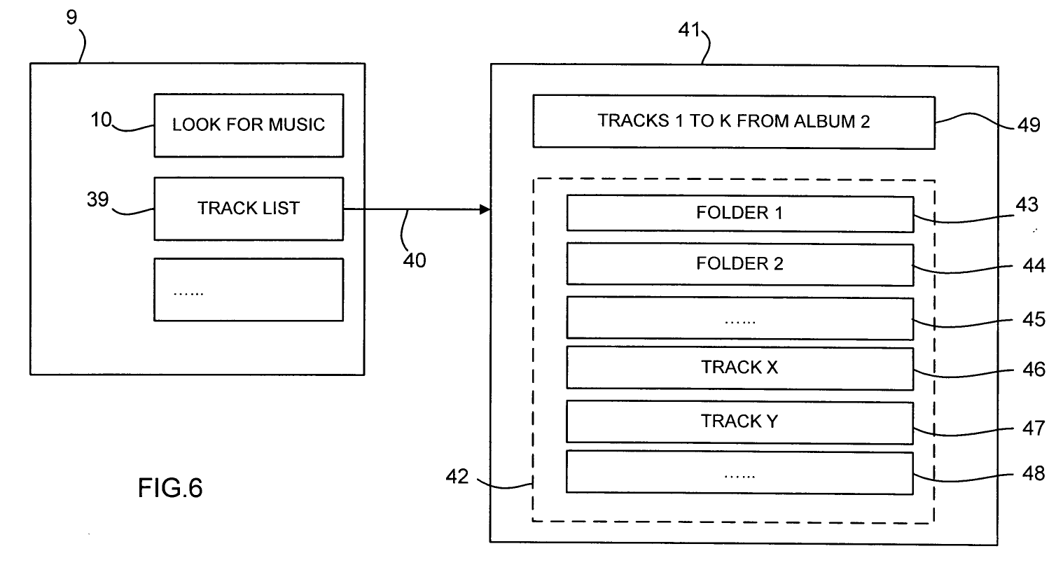

FIG. 6 shows an illustration of the main menu level 9 which, besides menu item 10, Look For Music, shows another menu item 39, Track List. Selecting menu item 39 allows the user to call the file directory in which the various audio files stored on the storage medium 5 or in the memory 3 are shown in structured form in folders with prescribed titles. This is shown in FIG. 6 by an arrow 40 which points from menu item 39 to a menu level 41 which is hierarchically subordinate to the main menu level 9. The menu level 41 shows such a file directory 42, which shows, by way of example, various folders 43 and 44 and a folder 45 to represent a possible multiplicity of further folders, and various tracks 46 and 47 and a track 48 to represent a possible multiplicity of further tracks from pieces of music. The folders 43, 44, 45 conceal further tracks from pieces of music. These tracks can be displayed by opening the folders 43, 44, 45. In addition to the file directory 42, menu level 41 contains a menu item 49 for the result of the menu-controlled selection of audio data already concluded previously, as described with reference to FIG. 5. Menu item 49 therefore conceals the result list 37 with tracks 1 to k on album 2 from artist 1. The user can therefore access the pieces of music previously selected under menu control when selecting menu item 39 too. It is also possible to show further result lists, containing tracks from pieces of music which have been compiled during other searches previously carried out, in menu level 41 via a separate menu item. This also allows the user simple access to these result lists.

We claim:

1. A method for menu-controlled selection of menu items having associated files containing at least one of audio data and video data, which comprises the steps of:
showing successively a first menu level having a plurality of first menu items and a second menu level having a plurality of second menu items on a display device, the plurality of second menu items being dependent on a first selection of one of the first menu items; and
showing again the first menu level with the plurality of first menu items after a selection of one of the second menu items.

2. The method according to claim 1, wherein after a second selection of one of the first menu items from the first menu level shown again, showing the second menu level with the second menu items being dependent on the first and the second selection of one of the first menu items.

3. The method according to claim 2, wherein when the first menu level is shown again, deactivating a first menu item from the first menu items if a preceding selection of the second menu item means that upon the second selection of the first menu item it would not be possible to select the second menu items on the second menu level.

4. The method according to claim 1, wherein after a selection of one of the second menu items when the first menu level is shown again, showing a statement associated with a selected second menu item on the first menu level.

5. The method according to claim 1, which further comprises providing at least one of the first menu items and the second menu items with a statement about a number of associated files.

6. The method according to claim 1, which further comprises showing a result for the menu-controlled selection of the menu items, the result containing at least one track representing at least one of selected audio data and selected video data.

7. The method according to claim 6, which further comprises showing the result together with a file directory for a storage medium on which the files containing at least one of the audio data and the video data are stored.

8. The method according to claim 1, which further comprises storing the files in a database.

9. The method according to claim 1, which further comprises providing a multimedia device to perform the method.

10. The method according to claim 9, which further comprises:
forming the multimedia device with an interface for connecting to a portable storage medium; and
after connection of the portable storage medium to the interface, reading metadata stored on the portable storage medium and the metadata are associated with files stored on the portable storage medium containing at least one of audio data and video data.

11. The method according to claim 10, wherein the files stored on the portable storage medium are associated with the first menu items and the second menu items using the metadata.

12. The method according to claim 10, which further comprises reading and storing the files stored on the portable storage medium in the multimedia device.

13. The method according to claim 1, which further comprises providing a multimedia device disposed in a motor vehicle to perform the method.

14. An apparatus for performing menu-controlled selection of menu items having associated files containing at least one of audio data and video data, the apparatus comprising:
a display device; and
a control device controlling successive showing of a first menu level having a plurality of first menu items and a second menu level having a plurality of second menu items on said display device, the plurality of second menu items being dependent on a first selection of one of the first menu items, said control device further controlling a renewed showing of the first menu level with the plurality of first menu items after selection of one of the second menu items on said display device.

15. The apparatus according to claim 14, further comprising an interface for connecting to a portable storage medium.

16. The apparatus according to claim 14, wherein said display device and said control device form a multimedia device disposed in a motor vehicle.
